(19) United States
(12) Patent Application Publication
(10) Pub. No.: US 2010/0274794 A1
(43) Pub. Date: Oct. 28, 2010

(54) System and method for representing information

(76) Inventor: Frank John Williams, Los Alamitos, CA (US)

Correspondence Address: Frank John Williams, 2711 Saint Albans Dr., Los Alamitos, CA, 90720, US

(21) Appl. No.: 12/386,921

(22) Filed: Apr. 23, 2009

(51) Int. Cl. G06F 17/30; G06N 5/02

(52) U.S. Cl. 707/769; 706/54; 707/E17.108

(57) ABSTRACT

A preferred method and system for dynamically and/or statically identifying, manipulating, registering, representing and comparing information are disclosed. In a preferred method, systems representing several elements and/or corresponding concepts, associate according to Associative Protocols such as CIRN, enabling networks to effectively represent information. In addition, this disclosure further teaches several additional methodologies for implementing said networks to perform at least one of a: conceptual relations between several data corpuses, contextual relations between several data corpuses, irrelevance removal, search, and trans-grammatical matching.

### BACKGROUND

1. Field of Invention

The present invention relates generally to a method for identifying information. More particularly, a novel method for identifying, registering and manipulating language information and other forms of information implementing a system network.

2. Description of Related Art

The computer and Internet revolutions are responsible for a series of innovations, scientific disciplines and applications, such as the Internet, computational linguistics, speech recognition, word processing, search engines and many others which have inherently changed the life and culture of the human and surrounding species. However, current technology fails to effectively manipulate language and information due to its lacking ability to diverge from specific grammatical structures thus avoiding and neglecting conceptually equivalent information. For example, in English, the words “red shoes” clearly and specifically define those items (shoes) which are identifiable by particular chromatic disposition (red). However, the same words as a query in today's search engines inevitably will generate all sorts of documents and sites simply comprising the words “red” and “shoes” in any random use or context. As a result, the query, will erroneously retrieve sites such as “the red car is a great option to show your new shoes” or “the white shoes look nice but your problem is the red scarf.” which indeed completely fail to express or respect the linguistic concept implied in the query. Then, to complicate things even further, human languages naturally permit dissimilar grammatical structures to express identical things, meanings and concepts. For example, in context, “the shoes are red” and “red shoes,” are and mean the same thing, further crippling and limiting the ability for machines and intelligent systems to effectively manipulate language and information.

In view of the present shortcomings, the present invention distinguishes over the prior art by providing heretofore a method and system to identify, to store, and to handle information in a more compelling way and manner, thus allowing current and future information systems the ability to handle information conceptually, while providing additional, unknown, unsolved and unrecognized advantages as described in the following disclosure.

### SUMMARY OF THE INVENTION

The present invention teaches certain benefits in use and construction which give rise to the objectives and advantages described below. The methods and systems embodied by the present invention overcome the limitations and shortcomings encountered when manipulating language information. The method(s) permits to identify information, register information, control information and manipulated information in context to its natural language, bypassing grammatical structures while avoiding conceptually irrelevant, erroneous and nonsensical data.

### OBJECTS AND ADVANTAGES

A primary objective inherent in the above described methods and systems of use is to provide several methods and systems to identify, register, control and handle language information as intended by its context while allowing information systems to diverge from limiting grammatical structures not taught in the prior arts while providing further advantages and objectives not taught by the prior art. Accordingly, several objects and advantages of the invention are:

Another objective is to avoid the generation of irrelevant and nonsense data during searching.

Another objective is to save user time by providing only conceptually matching data.

A further objective is to decrease the amount of effort implemented by users discriminating for irrelevant and nonsense data.

A further objective is to decrease the amount of effort implemented by users searching for relevant data.

A further objective is to improve the quality and quantity of results.

A further objective is to permit machines and programs to handle language more efficiently.

A further objective is to improve the ability of devices and portable devices to manipulate language information.

Another further objective is to permit the unification of the world's knowledge regardless of language and/or grammar.

Other features and advantages of the described methods of use will become apparent from the following more detailed description, taken in conjunction with the accompanying drawings which illustrate, by way of example, the principles of the presently described apparatus and method of its use.

### BRIEF DESCRIPTION OF THE DRAWINGS

The accompanying drawings illustrate examples of at least one of the best mode embodiments of the present system and method of use. In such drawings:

FIG. 1A through FIG. 1D are non-limiting exemplary block diagrams of a steps of the inventive method for identifying each element in a Data String;

FIG. 2A and FIG. 2B are non-limiting exemplary block diagrams and illustrations of some steps and some elements of the inventive method;

FIG. 3A through FIG. 3C are non-limiting exemplary block diagrams illustrating some steps of the inventive method identifying association between systems by implementing Associative Protocols such as a Conceptual Inter-Relating and Conceptual Networking Protocol or “CIRN;”

FIG. 4A through FIG. 4D are non-limiting exemplary block diagram illustration of some exemplary historical stages such as “previous stage and later stage” of systems and their associations or networks of the inventive method;

FIG. 5 is a non-limiting exemplary block diagram illustration of several data strings implementing different grammatical structures and their corresponding new conceived networks (NCN for short) of the inventive method;

FIG. 6 is a non-limiting block diagram illustration of a network of the inventive method incorporating new information and their corresponding associations;

FIG. 7 is a non-limiting exemplary block diagram illustration of steps and systems of the inventive method handling an information function or application such as that of a search and/or a search engine;

FIG. 8 is a non-limiting block diagram of many significant steps of the inventive system and method;

### DETAILED DESCRIPTION

The above described drawing figures illustrate the described methods and systems and use in at least one of its preferred, best mode embodiment, which are further defined in detail in the following description. Those having ordinary skill in the art may be able to make alterations and modifications from what is described herein without departing from its spirit and scope. Therefore, it must be understood that what is illustrated is set forth only for the purposes of example and that it should not be taken as a limitation in the scope of the present system and method of use.

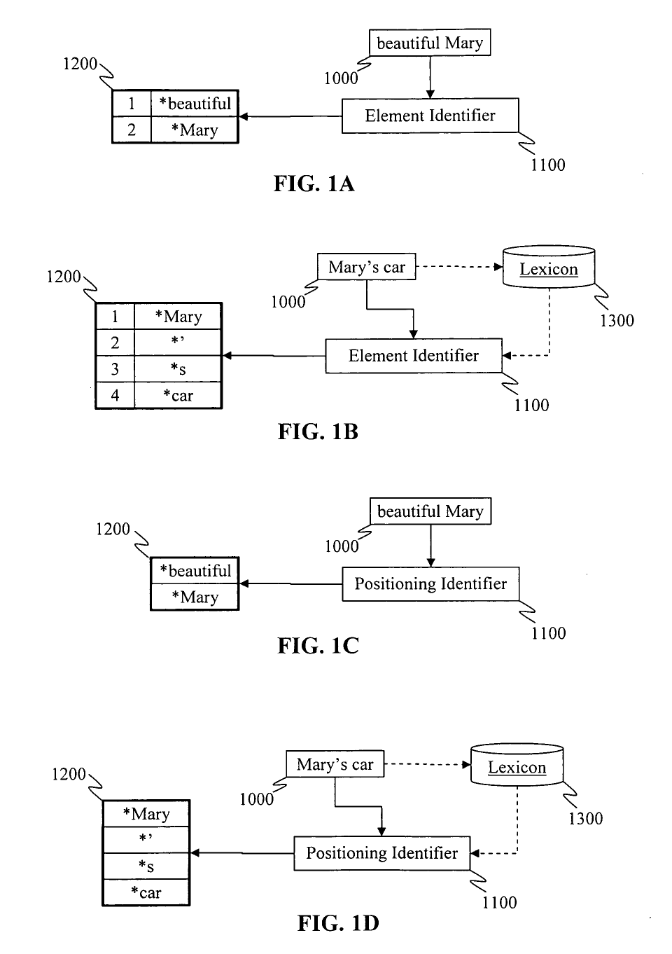

FIG. 1A is a non-limiting exemplary block diagram of a step of the inventive method identifying each element of a Data String. The Data String 1000 (FIG. 1A) or “beautiful Mary” comprises several elements such as “beautiful” and “Mary.” Then, the Element Identifier 1100 (FIG. 1A) identifies each of the elements of the Data String, thus resulting in the Element Login Data 1200 (FIG. 1A). Please note, the Element Login Data comprises information identifying the order, position and/or relative location of each element from the Data String, such as depicting the information identifying “beautiful” (*beautiful) with its log number (number 1) and depicting the information corresponding to “Mary” (*Mary) with its respective log number (number 2).

FIG. 1B is another non-limiting exemplary block diagram of a step of the inventive method identifying each element of a Data String this time implementing a Lexicon to aid the identification and/or individualization of each element. Accordingly, the Data String 1000 (FIG. 1B) or “Mary's car” comprises several elements such as “Mary,” the “apostrophe,” the character “s” and finally the word “car,” which were identifiable thanks to the optional Lexicon 1300 (FIG. 1B). Please note, without the Lexicon, the term “Mary's” would have appear as a single element; but the Lexicon provided the information needed to separate and/or identify each element independently. As a result, the Element Identifier 1100 (FIG. 1B) with aid of the Lexicon, identify each of the elements of the Data String, thus resulting in the Element Login Data 1200 (FIG. 1B). Please note, the Element Login Data comprises information identifying the order, position and/or relative location of each element from the Data String, such as depicting the information identifying “Mary” (*Mary) with its log number (number 1), depicting the information identifying the apostrophe (*') with its respective log number (number 2), depicting the information identifying the character “s” (*s) with its respective log number (number 3) and finally, depicting the information identifying “car” (*car) with its respective log number (number 4).

FIG. 1C is a non-limiting exemplary block diagram illustration of a step of the inventive method identifying each element of a Data String, this time averting a log number. Accordingly, the Data String 1000 (FIG. 1C) or “beautiful Mary” comprises several elements such as “beautiful” and “Mary.” Then, the Element Identifier 1100 (FIG. 1C) identifies each of the elements of the Data String, thus resulting in the Element Login Data 1200 (FIG. 1C). Please note, in this particular example, the elements of the Element Login Data are arranged from top to bottom without implementing a log number. Nonetheless, the order of the elements in the said Element Login Data, implicitly imply their sequence, position, and/or relative position.

FIG. 1D is a non-limiting exemplary block diagram illustration of a step of the inventive method identifying each element of a Data String, this time averting log numbers and implementing the aid of a lexicon for individually identifying each element. Accordingly, the Data String 1000 (FIG. 1D) or “Mary's car” comprises several elements such as “Mary,” the “apostrophe,” the character “s” and finally the word “car,” which were identifiable thanks to the optional Lexicon 1300 (FIG. 1D). Please note, without the Lexicon, the term “Mary's” would have appear as a single element; but the Lexicon provided the information needed to separate and/or identify each element independently. As a result, the Element Identifier 1100 (FIG. 1D) with aid of the Lexicon, identifies each of the elements of the Data String, thus resulting in the Element Login Data 1200 (FIG. 1D). Please note, in this particular example, there are no log numbers, but elements in the Element Login Data are arranged from top to bottom thus implicitly implying their sequence, position, and/or relative position.

Noteworthy, there a several methods for identifying the spatial location and/or spatial sequence of the different elements of a data string. In addition, many types of lexicons can be developed to identify and/or provide particular information required by particular steps, information identification and systems.

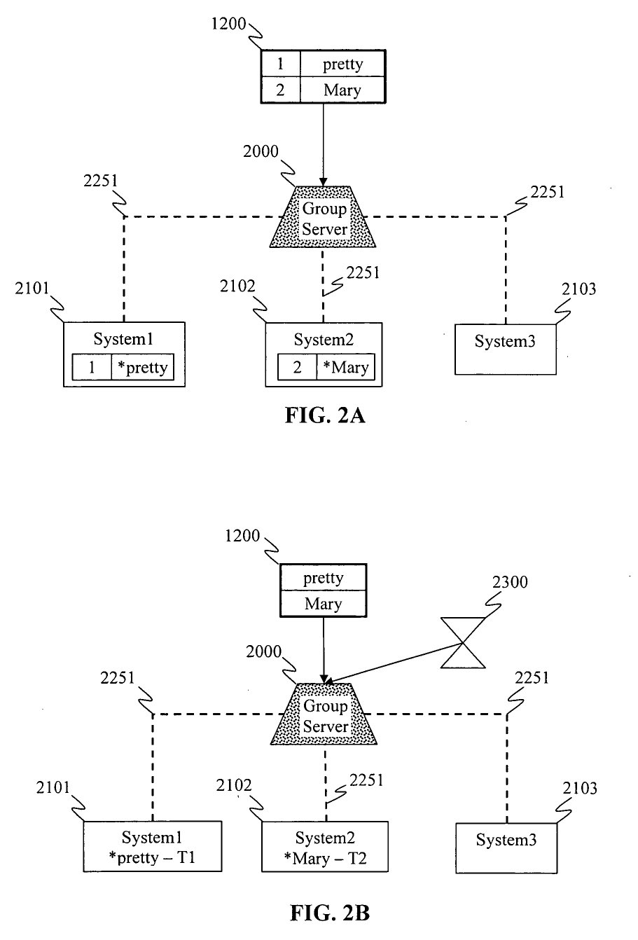

FIG. 2A is a non-limiting exemplary block diagram illustration of some steps and physical elements of the inventive method. The Element Login Data 1200 (FIG. 2A) is provided and/or retrieved by a Group Server 2000 (FIG. 2A) which distributes each element information to each system of a network. As a result, System1 2101 (FIG. 2A) is now responsible for identifying the concept of “pretty” (*pretty), and System2 2102 (FIG. 2A) is responsible for identifying its respective concept of “Mary” (*Mary). Please note, System3 2103 (FIG. 2A), is not assigned nor is representing any concept since the Element Login Data only involved two elements. In addition, please note the “Original Communication Path” or OCP 2251 (FIG. 2A) which is depicted as a set of dashed lines, permitting across the Group Server, for System1, System2 and System3 to communicate.

“Dashed lines” in this particular example and in future examples is and will continue to be used to depict and/or identify normal and/or standard communication lines/paths between the systems of a given network. In such fashion, when additional and/or replacing communication lines/paths are formed, removed, added and/or modified, the OCP can be differentiated.

FIG. 2B is another non-limiting exemplary block diagram illustration of some steps and some physical elements of the inventive method, this time implementing elements which the order is not explicitly identified by a log number or other. The Element Login Data 1200 (FIG. 2B) is provided and/or retrieved by a Group Server 2000 (FIG. 2B) which distributes each element information to each system of a network. As the Group Server logs in into each system to assign and/or activate its respective concept, a Time Function or Clock 2300 (FIG. 2B) is used to synchronize and/or identify the login time, thus allowing the systems to identify, which concept or corresponding is first, second, or other. As a result, System1 2101 (FIG. 2B) which is now responsible for identifying the concept of “pretty” (*pretty) also comprises the login time T1. In similar fashion, System2 2102 (FIG. 2B) which is responsible for identifying its respective concept of “Mary” (*Mary) also comprises the login time T2. Please note, System3 2103 (FIG. 2B), is not assigned any concept or login time, since the Element Login Data only involved two elements or concepts. In addition, please note the “Original Communication Path” or OCP 2251 (FIG. 2B) which is depicted as a set of dashed lines, and permits System1, System2 and System3 to communicate with each other across the Group Server. “Dashed lines” depicted and/or identify normal and/or standard communication lines/paths between the systems of the network. In such fashion, OCP can be differentiated from additional and/or replacing paths/lines for communication.

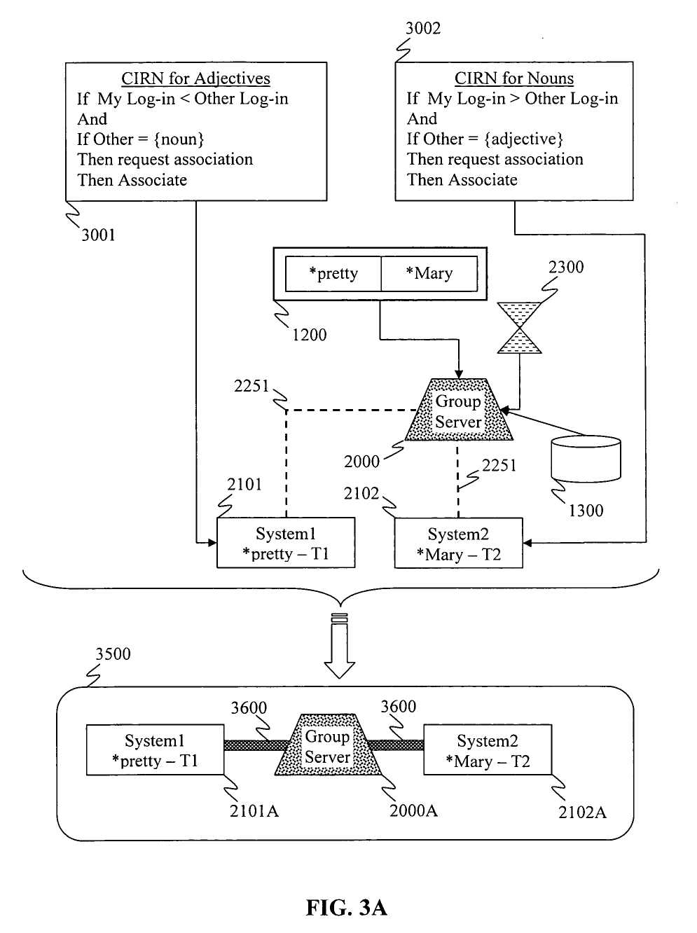

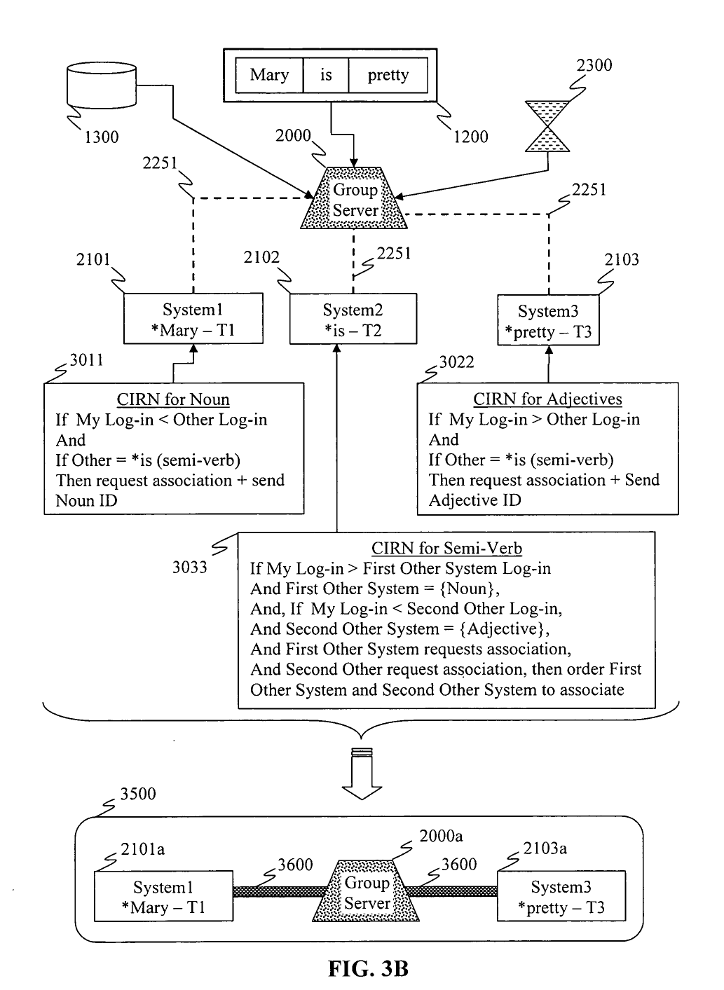

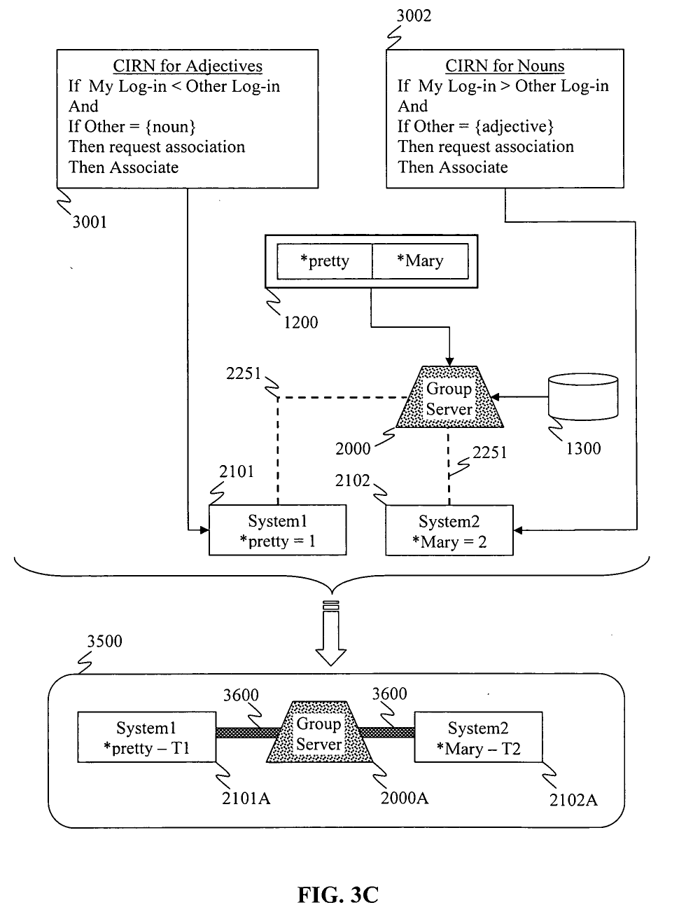

FIG. 3A is a non-limiting exemplary block diagram illustration of some steps of the inventive method including an Associative Protocol such as a Conceptual Inter-Relating and Conceptual Networking Protocol or “CIRN” for short. Accordingly, The First CIRN 3001 (FIG. 3A) depicts and/or describes at least one of a: associative rule, condition, circumstance, element, grammatical information and protocol needed to form or modify a system association (like a network), concept association and/or element association. For example, the First CIRN literally defines or describes that: if the system in question is an adjective, and the log-in value and/or log-in time of the said adjective system is lower (such as earlier) than the log-in of its neighbor system or “Other” system (next, previous or later), and if the Other System (later log-in) happens to be a noun, then, request and/or create an association between the systems. In similar fashion, the Second CIRN 3002 (FIG. 3A) depicts and/or describes at least one of a: associative rules, conditions, circumstances, elements, grammatical information and/or protocols needed to form a system, concept and/or element association. In contrast to the First CIRN, the Second CIRN corresponds to nouns, and literally describes that: if the system in question is indeed a noun, and its log-in value and/or log-in time is higher (such as later) than the log-in of its neighbor system or “Other” system (next, previous or later), and if the Other System (lower log-in) happens to be an adjective, then, request and/or create an association between the systems. In such fashion, the system of adjectives and nouns, form associations if their log-in values or order indeed matches grammar formats or others. The Element Login Data 1200 (FIG. 3A) does not contain log number to help identify which element is first or second but does provide an order which is inherent to its format. As a result, when the Element Login Data is provided and/or retrieved by the Group Server 2000 (FIG. 3A), the Time function or Clock 2300 (FIG. 3A) is used to identify and/or synchronize the log-in times when the Group Server, communicates and/or connects to each of the systems in the network. The Lexicon 1300 (FIG. 3A) provides the grammatical essence and/or other needed lexical information. Consequentially, System1 2101 (FIG. 3A) which represents *pretty shows a log-in time of T1, while the next system or System2 2102 (FIG. 3A) representing its respective concept in sequence or *Mary, has a log-in time of T2. Then, System1 communicates with System2 via the OCP 2251 (FIG. 3A) or “dashed lines” across the Group Server, and each implements their corresponding CIRN to identify or analyze if indeed a system association is inherent to the network. In fact, the log-in times and the grammatical essences of the systems do match the rules and/or conditions described by their respective CIRN (the adjective or “*pretty,” has a lower/earlier log-in or T1, and the next logged-in system or T2 is indeed a noun. Also, the noun or “*Mary” with a higher/later log-in time or T2, and the previous logged system or T1 is indeed an adjective). Accordingly, as mandate or requested by their respective CIRN, System1 and System2 do associate thus forming the New Conceived Network 3500 (FIG. 3A). In the New Conceived Network, System1 2101A (FIG. 3A) and System2 2102A (FIG. 3A) communicate across the Group Server 2000A (FIG. 3A) implementing the Newly Conceived Communication Path 3600 (FIG. 3A) or NCCP for short. Please note, the NCCP is depicted as a bold and thick line(s) to graphically differentiate them from normal, standard or original communication lines such as the OCP 2251 (FIG. 3A). The NCCP differs from OCP by implementing at least one of a: additional communication paths, different communication paths, and different communication protocols (like speed, encryptions, formats, signals, etc.). As a consequence, the New Conceived Network 3500 (FIG. 3A) effectively represents the elements of the Data String, or better said “concepts” of the Data String, with their corresponding associations (grammatical, semantic, conceptual, linguistic, etc.).

FIG. 3B is a non-limiting exemplary block diagram illustration of some steps of the inventive method including an Associative Protocol such as a Conceptual Inter-Relating and Conceptual Networking Protocol or “CIRN” for short. Accordingly, the First CIRN 3011 (FIG. 3B) depicts and/or describes at least one of a: associative rule, condition, circumstance, element, grammatical information and protocol needed to form or modify a system association (like a network), concept association and/or element association. For example, the First CIRN literally defines or describes that: if the system in question is an noun, and its log-in value and/or log-in time (My Log-in) is lower (such as earlier) than the log-in (Other Log-in) of its neighbor system or “Other” system (next, previous or later), and if the Other System (later log-in) happens to be a semi-verb (verbs of the form “to be”); then, request an association between the systems and providing its grammatical essence (noun) to the system of the found semi-verb. In similar fashion, the CIRN on the right, or Second CIRN 3022 (FIG. 3B) depicts and/or describes at least one of a: associative rule, condition, circumstance, element, grammatical information and protocol needed to form and/or modify a system association (like a network), concept association and/or element association. In contrast to the First CIRN, the Second CIRN 3022 (FIG. 3B) corresponds to adjectives, and literally describes that: if the system in question is indeed an adjective, and its log-in value and/or log-in time (My Log-in) is greater (such as later) than the log-in of its neighbor system (Other Log-in), and if the said neighbor or “Other System” (lower log-in) happens to be an semi-verb (verb form of the verb “to be”); then, request an association between the systems. On the other hand, the Third CIRN 3033 (FIG. 3B) depicts and/or describes the association function or rules for a semi-verb, literally describing or saying that: if the system in question is indeed a semi-verb and if its log-in value and/or log-in time (My Log-in) is greater (such as later) than the log-in of its neighbor system (First Other System Log-in) and said neighbor system (in this example, the system to the left) happens to be a noun, and that if the Log-in value or Log-in time of the “Second Other System” is greater than My Log-in (in this example, the system to the right or later system) and said “Second Other System” is an adjective; then, request or approve an association between the “First Other System” (system to the left) and the “Second Other System” (system to the right). In such fashion, the respective systems of adjectives and nouns, will form associations if their log-in values or orders per se, indeed match the grammatical formats and/or spatial relations-geometries of the given language. The Element Login Data 1200 (FIG. 3B) comprises three elements which do not contain log numbers to help identify which element is first, second or third; but the Element Login Data, does provide an order which is inherent to its format and/or the sequence of its elements. As a result, when the Element Login Data is provided and/or retrieved by the Group Server 2000 (FIG. 3B), the Time function or Clock 2300 (FIG. 3B) is used to identify and/or synchronize the log-in times when the Group Server, communicates and/or connects to each of the systems in the network. The Lexicon 1300 (FIG. 3B) provides the grammatical essence and/or other needed lexical information. Consequentially, System1 2101 (FIG. 3B) which represents *Mary shows a log-in time of T1, System2 2102 (FIG. 3B) which represents *is (the semi-verb) shows a log-in time of T2, and the last system or System3 2103 (FIG. 3B) representing its respective concept in sequence or *pretty, has or displays a log-in time of T3. Then, all system will communicate with each other or with their corresponding immediate neighbors (the method exemplify in this figure) for trying to verify, find or discover if system associations are possible as described by each of their corresponding CIRN. As a result, System1 2101 (FIG. 3B) communicates with System2 2102 (FIG. 2B) via the OCP 2251 (FIG. 3A) or “dashed lines” across the Group Server, and each implements their corresponding CIRN to identify or analyze or discover if indeed a system association is inherent or possible in the network. In fact, the log-in times, grammatical essences, and other possible information of both systems do match the rules and/or conditions described by their respective CIRN (the noun or *Mary is first—has a lower/earlier log-in or T1, and the semi-verb or *is second—has a greater/later log-in or T2). Meanwhile, System3 2103 (FIG. 3B) also communicates with System2 2102 (FIG. 3B) via the OCP 2251 (FIG. 3B) or “dashed lines” across the Group Server for identifying, discovering or verifying if a system association is possible too. Accordingly, System3 and System2 implement their corresponding CIRN. As a result, an association is also achieved and/or mandated since the respective log-in times, grammatical essences, and other information, matched the conditions as described by each of their CIRN (the conditions for System3 and the conditions for System2 are true in both cases). Consequentially, for this particular example, System2 orders System1 and System3 to “super associate” or form a New Conceived Network 3500 (FIG. 3B). Please note, in the New Conceived Network, System1 2101a (FIG. 3B) and System3 2103a (FIG. 3B) communicate across the Group Server 2000a (FIG. 3B) this time implementing the Newly Conceived Communication Path 3600 (FIG. 3B) or NCCP for short. Please note, once again, NCCP communications or associations are depicted as bold and thick line(s) to graphically differentiate them from normal, standard or original communication lines such as the OCP 2251 (FIG. 3B). The NCCP differs from OCP by implementing at least one of a: additional communication paths, different communication paths, and different communication protocols (like speed, encryptions, formats, signals, etc.). Consequentially, the New Conceived Network 3500 (FIG. 3B) effectively represents the elements of the Data String, or better said “concepts” of the Data String, with their corresponding associations (grammatical, semantic, conceptual, linguistic, etc.).

FIG. 3C is a non-limiting exemplary block diagram illustration of some steps of the inventive method including an Associative Protocol such as a “CIRN” implementing log-in values/numbers. Accordingly, The First CIRN 3001 (FIG. 3C) depicts and/or describes at least one of a: associative rule, condition, circumstance, element, grammatical information and protocol needed to form or modify a system association (like a network), concept association and/or element association. For example, the First CIRN literally defines or describes that: if the system in question is an adjective, and the log-in value and/or log-in time of the said adjective system is lower (such as earlier) than the log-in of its neighbor system or “Other” system (next, previous or later), and if the Other System (later log-in) happens to be a noun, then, request and/or create an association between the systems. In similar fashion, the Second CIRN 3002 (FIG. 3C) depicts and/or describes at least one of a: associative rules, conditions, circumstances, elements, grammatical information and/or protocols needed to form a system, concept and/or element association. In contrast to the First CIRN, the Second CIRN corresponds to nouns, and literally describes that: if the system in question is indeed a noun, and its log-in value and/or log-in time is higher (such as later) than the log-in of its neighbor system or “Other” system (next, previous or later), and if the Other System (lower log-in) happens to be an adjective, then, request and/or create an association between the systems. In such fashion, the system of adjectives and nouns, form associations if their log-in values or order indeed matches grammar formats or others. The Element Login Data 1200 (FIG. 3C) contains a log-in number that helps identify which element is first or second. As a result, the Element Login Data is used by the Group Server 2000 (FIG. 3C) to identify the order, sequence, or log-in of each system in the network. In addition, the Lexicon 1300 (FIG. 3A) provides the grammatical essence and/or other needed lexical information. Then, System1 communicates with System2 via the OCP 2251 (FIG. 3C) or “dashed lines” across the Group Server, and each implements their corresponding CIRN to identify or analyze if indeed a system association is inherent to the network. In fact, the log-in values (1 and 2) and the grammatical essences of the systems do match the rules and/or conditions described by their respective CIRN (the adjective or “*pretty,” has a lower/earlier log-in=1, and the next logged-in system with log-in=2, is indeed a noun. Also, the noun or “*Mary” with a log-in=2, and the previous logged system or *pretty” has a log-in=1 is indeed an adjective). Accordingly, as mandate or requested by their respective CIRN, System1 and System2 do associate thus forming the New Conceived Network 3500 (FIG. 3C). In the New Conceived Network, System1 2101A (FIG. 3A) and System2 2102A (FIG. 3C) communicate across the Group Server 2000A (FIG. 3A) implementing the Newly Conceived Communication Path 3600 (FIG. 3A) or NCCP for short. Please note, the NCCP is depicted as a bold and thick line(s) to graphically differentiate them from normal, standard or original communication lines such as the OCP 2251 (FIG. 3C). The NCCP differs from OCP by implementing at least one of a: additional communication paths, different communication paths, and different communication protocols (like speed, encryptions, formats, signals, etc.). As a consequence, the New Conceived Network 3500 (FIG. 3C) effectively represents the elements of the Data String, or better said “concepts” of the Data String, with their corresponding associations (grammatical, semantic, conceptual, linguistic, etc.).

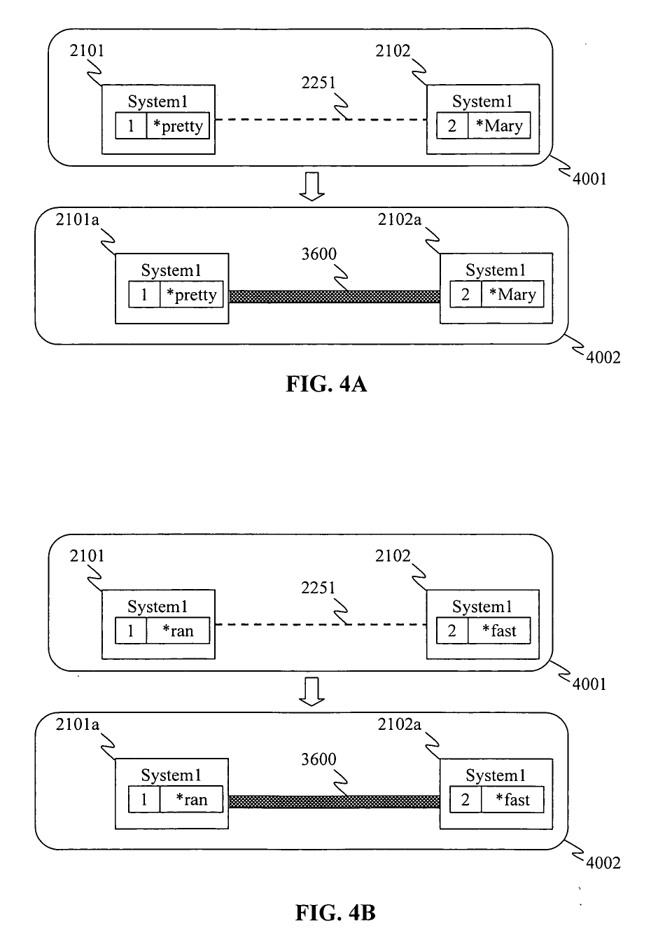

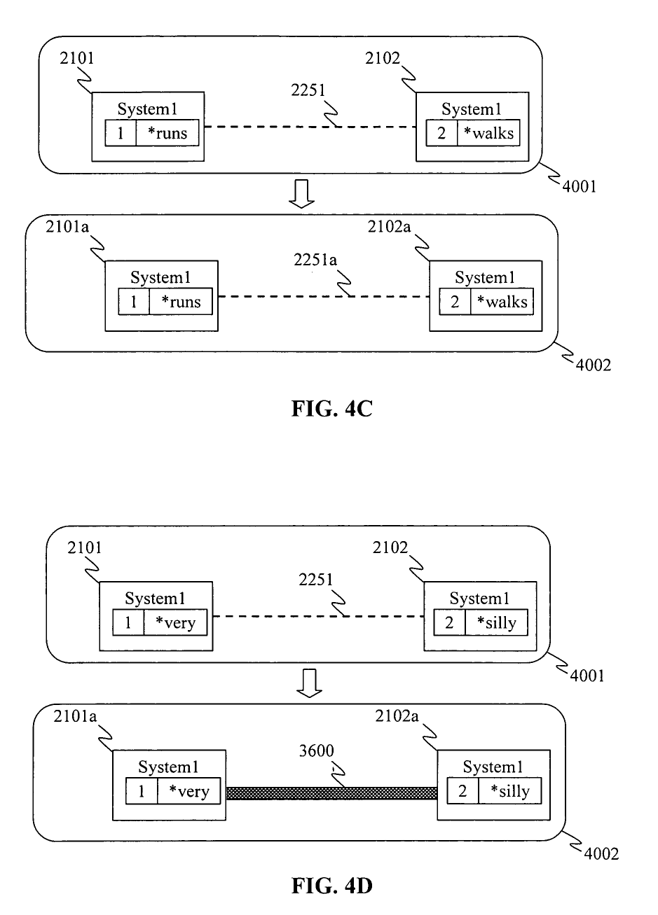

FIG. 4A is a non-limiting exemplary block diagram illustration of some exemplary historical stages such as “previous stage and later stage” of system associations of the inventive method. Accordingly, in the previous or First Historical Stage 4001 (FIG. 4A), System1 2101 (FIG. 4A) or *pretty (representing any information directly and/or indirectly identifying the concept of pretty, such as word, group identifier, eeggi, eeggi-grammar, etc.) and System2 2102 (FIG. 4A) or *Mary (representing any information directly and/or indirectly identifying the concept of Mary, such as a word, group identifier, eeggi, eeggi-grammar, etc.) simply communicate across a standard communication path or OCP 2251 (FIG. 4A). Please note, System1 represents the first word or concept as indicated by its Log-in data of 1, and System2 represents the next word or concept in sequence as indicated by its corresponding Log-in Data of 2. Then, because of CIRN and discovered system association, the network shapes or forms the new configuration depicted in the Second Historical Stage 4002 (FIG. 4A); wherein System1 2101a (FIG. 4A) and System2 2101a (FIG. 4A) are now linked across a Resulting NCCP 3600 (FIG. 4A), thus successfully associating the systems representing the adjective and the noun. Noteworthy, because in the later stage or Second Historical Stage a NCCP is depicted necessarily means that no OCP exists or can be used.

FIG. 4B is another non-limiting exemplary block diagram illustration of some exemplary historical stages such as “previous stage and later stage” of system associations of the inventive method implementing different grammatical elements. Accordingly, in the previous or First Historical Stage 4001 (FIG. 4B), System1 2101 (FIG. 4B) or *ran (which is a verb), and System2 2102 (FIG. 4B) or *fast (which is an adverb), are simply linked (communicate) across a standard communication path or OCP 2251 (FIG. 4B). Please note, System1 and System2 represent the sentence “ran fast” respectively. Then, because of CIRN and discovered system association, the network forms the new configuration depicted in the Second Historical Stage 4002 (FIG. 4B); wherein System1 2101a (FIG. 4B) and System2 2101a (FIG. 4B) are now linked across a Resulting NCCP 3600 (FIG. 4B), thus successfully associating the systems representing verb and the adverb. Noteworthy, because in the later stage or Second Historical Stage a NCCP is depicted necessarily means that no OCP exists or can be used.

FIG. 4C is another non-limiting exemplary block diagram illustration of some exemplary historical stages of system associations of the inventive method comprising information which results in no system association. Accordingly, in the First Historical Stage 4001 (FIG. 4C), System1 2101 (FIG. 4C) or *runs (which is a verb), and System2 2102 (FIG. 4C) or *walks (which is another in sequence verb), are simply linked (communicate) across a standard communication path or OCP 2251 (FIG. 4C). Please note, System1 and System2 represent the sentence “runs walks” respectively. Then, because of CIRN and undiscovered system association, the network remains identical as depicted in the Second Historical Stage 4002 (FIG. 4C); wherein System1 2101a (FIG. 4B) and System2 2101a (FIG. 4B) are still linked across a OCP 2251a (FIG. 4B), effectively avoiding to represent non-conceptual or irrational data.

FIG. 4D is another non-limiting exemplary block diagram illustration of some exemplary historical stages of “system associations” of the inventive method comprising several types of adjectives. Accordingly, in the First Historical Stage 4001 (FIG. 4D), System1 2101 (FIG. 4D) or *very (which is a modifier type adjective), and System2 2102 (FIG. 4D) or *silly (which is another type or standard adjective), are simply linked (communicate) across a standard communication path or OCP 2251 (FIG. 4D). Please note, System1 and System2 represent the sentence “very silly” respectively. Then, because of CIRN a system association is discovered, thus modifying or forming the new network depicted in the Second Historical Stage 4002 (FIG. 4D); wherein System1 2101a (FIG. 4D) and System2 2101a (FIG. 4D) are still linked across a NCCL 3600 (FIG. 4D), effectively representing the corresponding concepts and any association between said concepts.

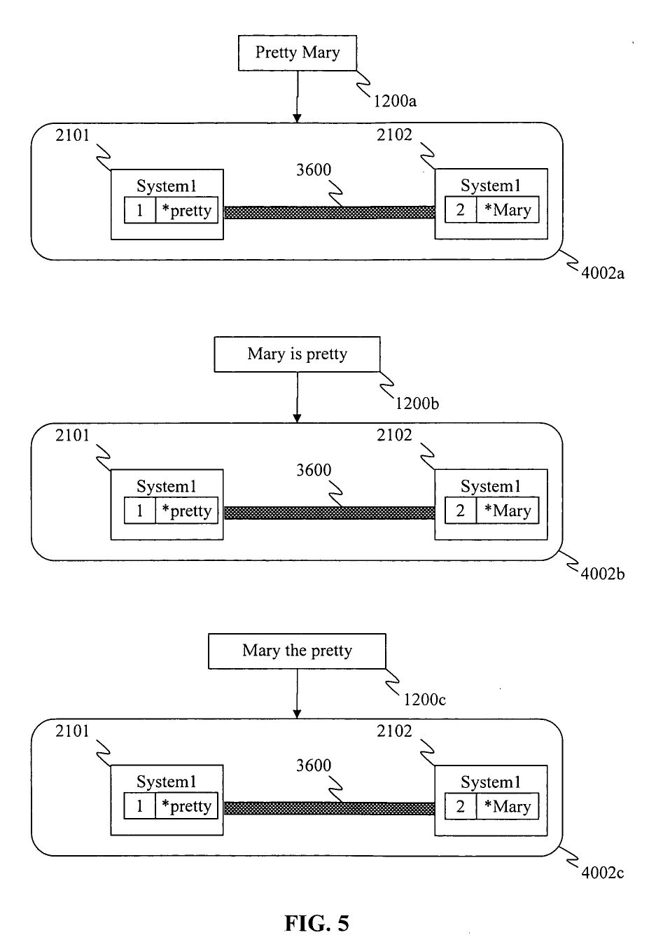

FIG. 5 is a non-limiting exemplary block diagram illustration of several data strings implementing different grammatical structures and their corresponding new conceived networks (NCN for short) of the inventive method. Accordingly, the First Data String 1200a (FIG. 5) or “pretty Mary” implementing a specific grammatical arrangement, forms the First NCN 4002a (FIG. 5). Please note the systems and associations of the network. The Second Data String 1200b (FIG. 5) or “Mary is pretty” implementing a different grammatical arrangement, forms the Second NCN 4002b (FIG. 5). As illustrated, the Second NCN (systems, elements, links, etc.) is indeed identical to the First NCN. In addition, the Third Data String 1220c (FIG. 5) or “Mary the pretty” implementing yet another grammatical arrangement, forms the Third NCN 4002c (FIG. 5); which is once again identical to the First NCN and the Second NCN. Consequentially, the described inventive method effectively equalizes different grammatical arrangements implying identical concepts or ideas.

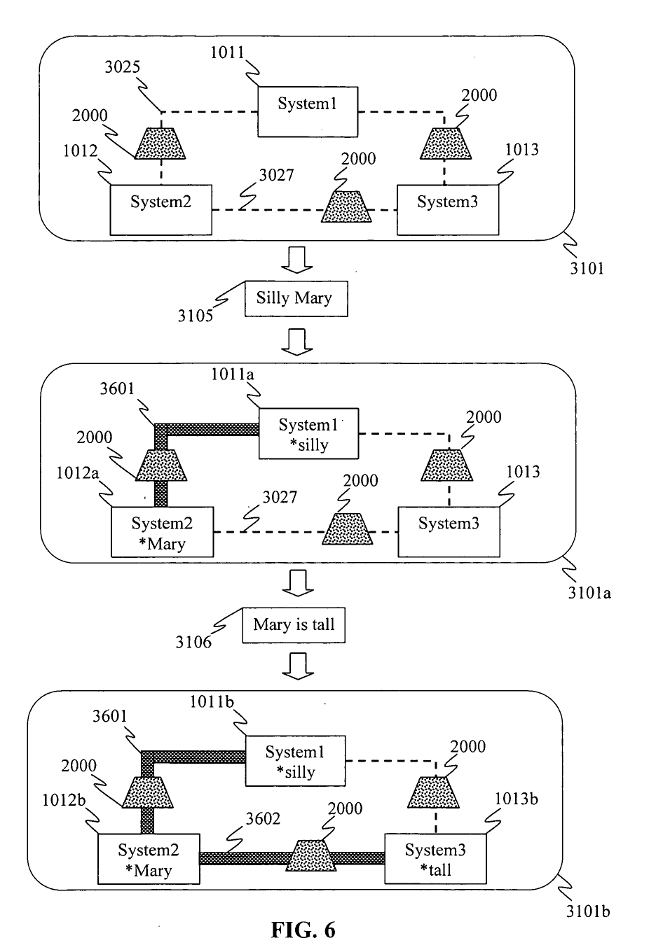

FIG. 6 is a non-limiting block diagram illustration of a network of the inventive method incorporating new information and associations. Accordingly, in the First Network 3101a (FIG. 6) System1 1011 (FIG. 6), System 2 1012 (FIG. 6) and System3 1013 (FIG. 6) represent no concepts, words, eeggi, or others. In addition, they can all communicate across the Group Server 2000 (FIG. 6) implementing the First OCP 3025 (FIG. 6), the Second OCP 3026 (FIG. 6) and the Third OCP 3027 (FIG. 6). Then, the First Data String 3105 (FIG. 6) is analyzed, entered, register, or other, thus resulting in the Second Network 3101a (FIG. 6). This time, System1 1011a (FIG. 6) represents *silly (any information directly and/or indirectly identifying the concept of “silly”), and System2 1012a (FIG. 6) represents is respective word *Mary (any information directly and/or indirectly identifying the concept of “Mary”). In addition, both systems continue to be linked across the Group Server 2000 (FIG. 6) but this time, in addition, both systems can also communicate implementing the First NCCP 3601 (FIG. 6). In this Second Network 3101a (FIG. 6), System3 has not experienced any changes. Then, another data string or Second Data String 3106 (FIG. 6) or “Mary is tall” is processed, entered, represented, or other, thus resulting in the last network or Third Network 3101b (FIG. 6). This time, the network once again, changes to welcome the latest information. As a result, System2 1012b (FIG. 6) and System3 1013b (FIG. 6), now representing *tall, are linked via a Second NCCP 3602 (FIG. 6). As a consequence, the Third Network, effectively represents the information provided by the First Data String and Second Data String; but most importantly, System2 1012b (FIG. 6) effectively links the concept of *Mary to *silly and to *tall, while enabling the network to respond to a question such as “Is Mary silly and tall?” with a prospective positive answer.

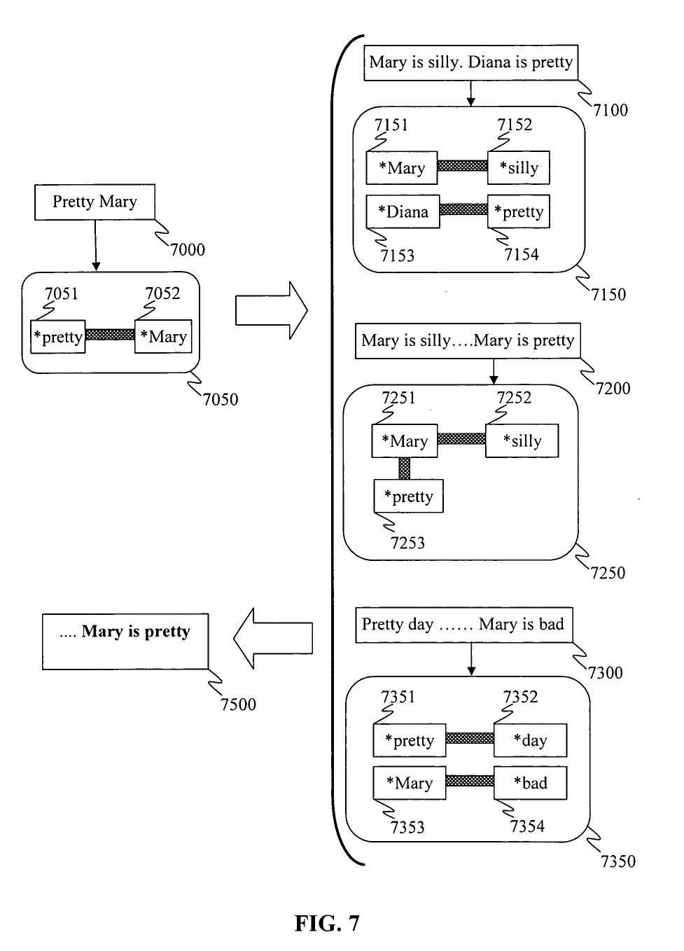

FIG. 7 is a non-limiting exemplary block diagram illustration of steps and systems of the inventive method handling an information function or application such as that of a search and/or a search engine. The Query 7000 (FIG. 7) or “pretty Mary” is responsible for forming its corresponding Query NCN 7050 (FIG. 7) comprising several systems and associations or NCCP (such as links) representing the corresponding elements of the Query with their respective associations (if any). In similar fashion, the First Document 7100 (FIG. 7) forms its corresponding First NCN 7150 (FIG. 7), the Second Document 7200 (FIG. 7) forms its corresponding Second NCN 7250 (FIG. 7), and the Third Document 7300 (FIG. 7) is responsible for forming its corresponding Third NCN 7350 (FIG. 7). Comparing the different networks and respective systems with that of the network and systems of the Query it can be observed that: in this particular example, the Query NCN 7050 (FIG. 7) links the First Query System 7051 (FIG. 7) or *pretty with the Second Query System 7052 (FIG. 7) or *Mary. However, the First NCN 7150 (FIG. 7), links its corresponding *Mary System 7151 (FIG. 7) to an *silly System 7152 (FIG. 7), while separately linking its *Diana System 7153 (FIG. 7) to a *pretty System 7154 (FIG. 7); consequentially, there is no match and the corresponding First Document, is not retrieved or displayed in the Retrieved Documents 7500 (FIG. 7). But, in the Second NCN 7250 (FIG. 7) its *pretty System 7253 (FIG. 7) is also linked to another *Mary System 7251 (FIG. 7), therefore, there is a match and the corresponding Second Document 7200 (FIG. 6) is retrieved and/or displayed in the Retrieved Documents 7500 (FIG. 7). Please note, even when its *Mary System 7251 (FIG. 7) is additionally linked to a *silly System 7252 (FIG. 7) it does not change the fact of a “network match” between the Query NCN and the Second NCN. Finally, in the Third NCN 7350 (FIG. 7), its respective *pretty System 7351 (FIG. 7) is linked to a *day System 7352 (FIG. 7), while its respective *Mary System 7353 (FIG. 7) is linked to a *bad System 7354 (FIG. 7); consequentially, there are no matches and the corresponding Third Document 7300 (FIG. 7), is not retrieved or displayed in the Retrieved Documents 7500 (FIG. 7).

Noteworthy, within the several types of networks (wireless, Intranet, Internet, etc.), there are several possible configurations, comprising different types of network elements or systems (routers, server, secured servers, processors, computers, etc.) each possibly comprising and/or involving several network function, steps of the inventive methods and responsibilities, without ever departing from the main spirit and scope of the inventive method and system.

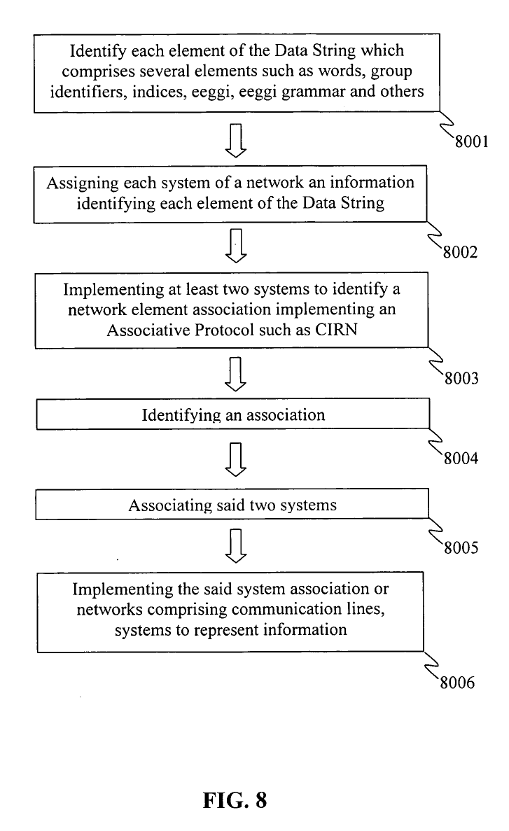

FIG. 8 is a non-limiting block diagram of many significant steps of the inventive method. Accordingly, the First Step 8001 (FIG. 8) involves identifying each element of a data string or data corpus; wherein said elements can be at least one of a: word, words, group identifier, eeggi, eeggi-grammar or others. The Second Step 8002 (FIG. 8) involves the step(s) and/or method(s) of assigning a system, such as a computer, server, chip, processor, intelligent apparatus, and others the responsibility of representing an element and/or corresponding concept. The Third Step 8003 (FIG. 8) involves identifying, verifying and/or discovering if an association between several systems is likely or possible implementing an Associative Protocol such as, but not limited to, CIRN. The Fourth Step 8004 (FIG. 8) involves the obvious step of identifying an association between the systems. The Fifth Step 8005 (FIG. 8) involves the step of factually associating at least two systems representing their respective elements. The Sixth Step 8006 (FIG. 8) involves implementing the newly configured and/or conceived networks to represent information for information applications such as registries, search engines, trans-grammatical concept comparisons, etc.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method and system for dynamically and/or statically identifying, registering, comparing, and manipulating information can be appreciated. The described method overcomes many of the limitations encountered by current information technologies such as databases, and information applications such as search engines, speech recognition, word processors, and others which fail to effectively associate relating data and dynamically grow with new information.

1. A method of representing information comprising the steps of:
a) Identifying a first system in a network,
b) Identifying a second system in a network,
c) Identifying a first element in a data corpus
d) Identifying a second element in said data corpus
e) Implementing said first system to represent said first element,
f) Implementing said second system to represent said second element,
g) Implementing said first system and said second system for identifying a system association implementing an associative protocol, such as CIRN,
h) Identifying an association,
i) Associating said first system and said second system implementing an exclusive communications protocol.

2. A method of retrieving information comprising the steps of:
a) Identifying a first element in a query corpus
b) Identifying a second element in said query corpus
c) Implementing a first system to identify said first element; wherein said first system forms part of a first network,
d) Implementing a second system to represent said second element; wherein said second system forms part of said first network,
e) Implementing said first system and said second system to identify an association implementing an associative protocol, such as CIRN,
f) Forming a second network comprising said first system and said second system
g) Identifying a third network identical to said second network,
h) Retrieving information relating to said third network
